(19) United States
(12) Patent Application Publication
(10) Pub. No.: US 2017/0124214 A1
(43) Pub. Date: May 4, 2017

(54) DETERMINING DATA FIELD OFFSETS USING A DOCUMENT OBJECT MODEL REPRESENTATION

(71) Applicant: International Business Machines Corporation, Armonk, NY (US)

(72) Inventors: ROBERT O. DRYFOOS, NEW CANAAN, CT (US); BRADD A. KADLECIK, WAPPINGERS FALLS, NY (US); COLETTE A. MANONI, BREWSTER, NY (US)

(21) Appl. No.: 14/924,973

(22) Filed: Oct. 28, 2015

(51) Int. Cl. G06F 17/30

(52) U.S. Cl. CPC G06F 17/30917; G06F 17/30595; G06F 17/30923; G06F 17/30327

(57) ABSTRACT

Embodiment herein relate to generating an offset information tree. The offset information tree includes a plurality of nodes. Each node further includes offset information that corresponds to a data portion of a data area. A node can be identified from the plurality of nodes in response to a request for access to the data area. Further, offset information can be determined from the node identified from the plurality of nodes and that the offset information can be utilized to directly access a desired data portion of the data area.

### BACKGROUND

The disclosure relates generally to data field offsets, and more specifically, to determining data field offsets using a document object model representation.

In general, contemporary parsers utilize metadata to discover where a field is located. In one example, a contemporary parser starts at the beginning of the metadata and parses through that metadata until arriving at a desired field. In another example, a contemporary parser utilizes a fixed starting point, designated upon creation of the metadata, from which all fields must be referenced.

Contemporary parsers can locate elements by traversal of a tree in a left to right methodology from a first starting point. In turn, when using document object model (DOM) based approaches of representing data, such as through data format description language (DFDL), additional overhead is generated due to at least traversing the tree when locating a particular field or element (additional overhead can also be due to parsing a data area to create the tree). That is, parsing through each part of a tree until a desired node (element/field) is located can be a costly exercise, especially for queries or changes on a field/element basis.

### SUMMARY

According to an embodiment, a method comprises generating an offset information tree. The offset information tree includes a plurality of nodes. Each node further includes offset information that corresponds to a data portion of a data area. A node can be identified from the plurality of nodes in response to a request for access to the data area. Further, offset information can be determined from the node identified from the plurality of nodes and that the offset information can be utilized to directly access a desired data portion of the data area.

According to other embodiments, the above method can be implemented via a system or computer program product.

Additional features and advantages are realized through the techniques of the embodiments. Other embodiments and aspects are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a process flow of system in accordance with an embodiment;

FIG. 2 illustrates an offset information in accordance with an embodiment;

FIG. 3 illustrates a process flow of system in accordance with an embodiment; and

FIG. 4 illustrates a processing system in accordance with an embodiment.

### DETAILED DESCRIPTION

In view of the above, a faster lookup methodology is provided herein to quickly locate a desired item (element/field) and calculate the offset to this desired item from a root node of the tree.

Embodiments disclosed herein may include a system, method, and/or computer program product (herein system) that provides direct access to data portions of a data area via a tree of metadata. For instance, the system can generate a tree of nodes. Each node can include metadata or offset information that facilitates the flexibility to have any starting location within the data area when performing a lookup operation of a data portion. The offset information includes an offset that is relative to a parent node (if the node is a parent then the offset is zero). In this way, the system then can utilize the offset information as a straight line into the data area, thereby avoiding parsing the data area itself.

An offset of a child node is based on a summation of offsets to each parent node of a tree until a root node is encountered. For example, the system generates a document object model (DOM) representation of metadata that contains a length of each node (element/field) and an offset to a corresponding parent node in a tree to facilitate an efficient calculation of the offset, regardless of which parent nodes are specified as the root. Further, the system is configured to locate a correct node through a hash table lookup and provide a quick summation of parent node offsets to allow for the efficient calculation of the offset to locate the field/element for a query or modification.

In an embodiment, the metadata can be represented through data format description language (DFDL) that provides a DOM based data model for representing the data. A DOM tree can be kept in core and enhanced to contain data type, data length, data offset, data conditions, etc. in efficient in-core representations to be able to perform field/element based operations independent of which programming language is used. Thus, the data modelling allows for C++/Java classes or JSON/XML documents (or the like) to gain a mapping of traditional databases as the data model acts as an intermediate layer between the two through the use of application programmable interfaces that allow for specification of root elements and lookups of data elements by field or tag names.

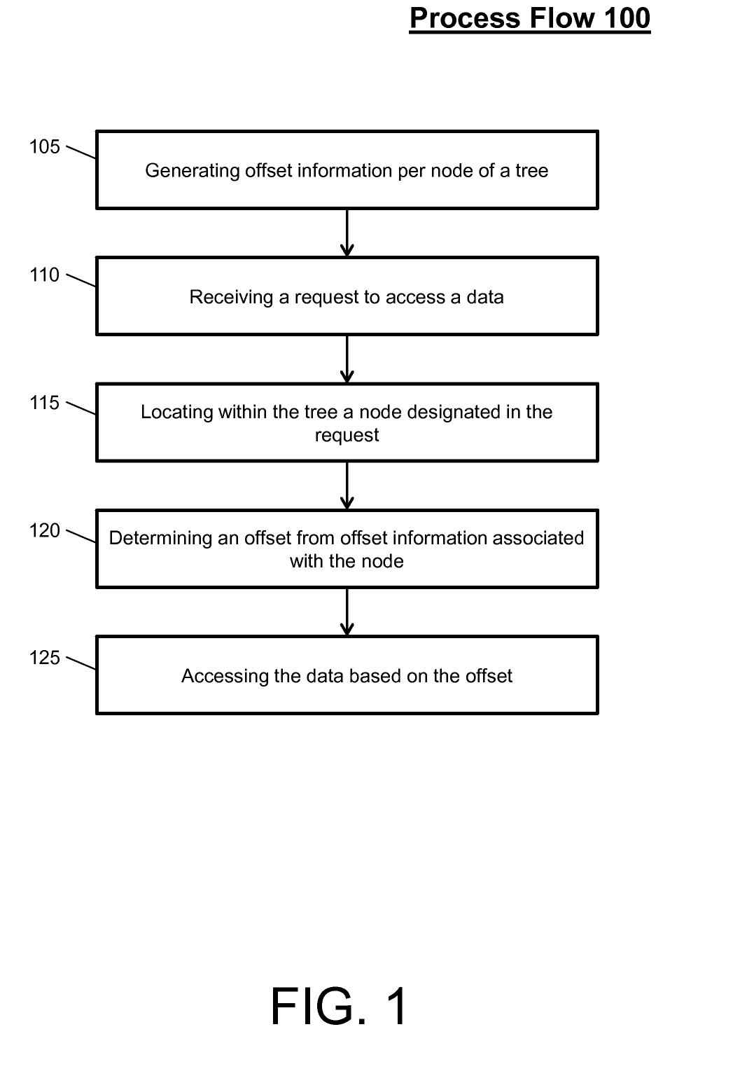

Turning now to FIG. 1, a process flow 100 is generally shown in accordance with an embodiment. In general, the process flow 100 facilities access to portions of data of a data area (e.g., data block, data buffer, memory, etc.), thereby avoiding a need for a fixed starting point and providing direct and fast access to the data itself. Direct access by the process flow 100 can also be applied to cases where the process flow 100 does not begin with the data itself, such as while the data is being constructed and/or during a data shift (e.g., in cases regarding conditional data, variable length data, etc.).

The process flow 100 begins at block 105, where offset information is generated per node of a tree. The tree (e.g., offset information tree) can be configured to manage multiple data areas of a same type. Each node corresponds to portions of data, such as data located in a data area and the data area itself. Offset information includes a relation of a child node to a parent node (distance of a portion of data of that child node to a portion of data of the parent node within the data area). The relation to the parent node can be represented by a value or a formula. A formula can be used in the case where the data is unknown. In addition, offset information can include a length of the portion of data. Thus, the offset information can be collectively the metadata describing the data in the data area (note that the tree is store separate from the data itself).

At block 110, a request is received to access the data. The request can be generated by an originator, such as an application or system code that needs access to the data. The request can include metadata that designates any node of the tree generated at block 105 and/or that designates a parent node. This parent node can be a real root node that begins the entire tree or sublevel node that is being utilized as a root node.

At block 115, a designated node of the request is located within the tree. For instance, a child node (e.g., the designated node) that the application or system code is interested in is located by utilizing metadata of the request.

At block 120, once a child node is identified, the offset information associated with that child node is utilized to determine an offset from the parent identified in the request. This offset facilitates a straight line or direct access to a data portion within the data area corresponding to the designated node.

At block 125, the originator directly accesses the data portion based on the determined offset.

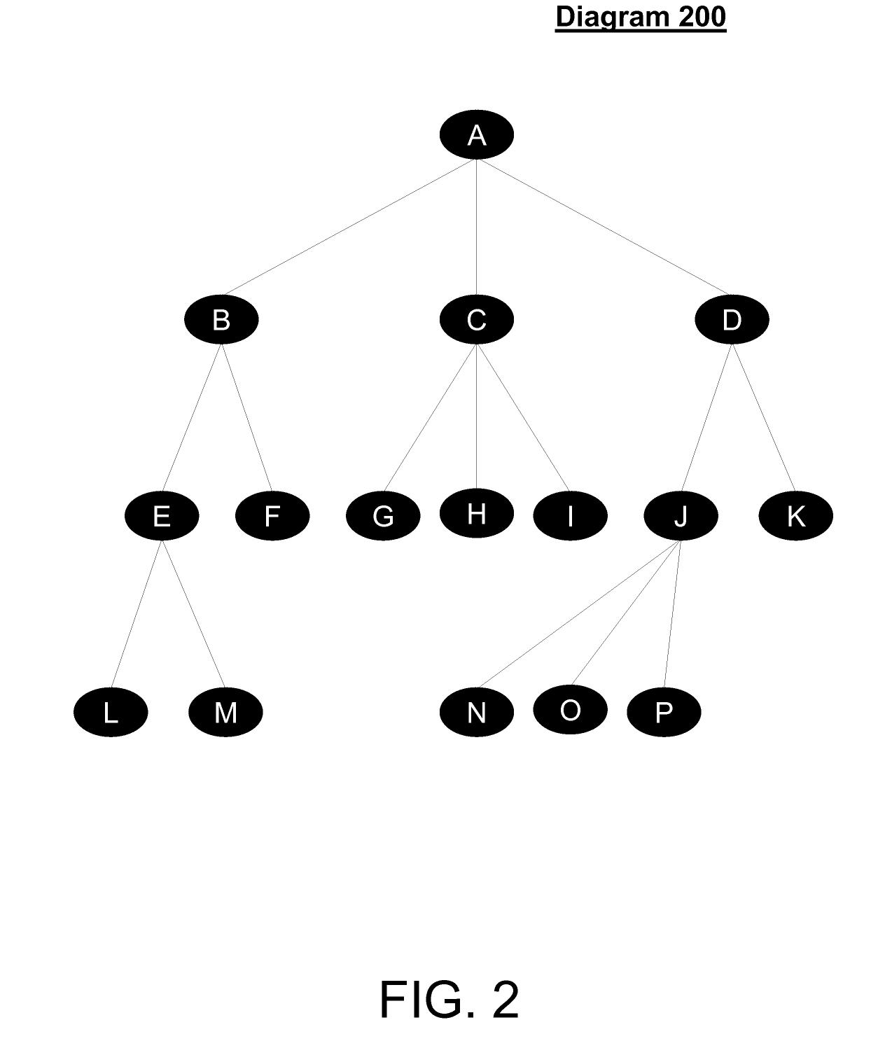

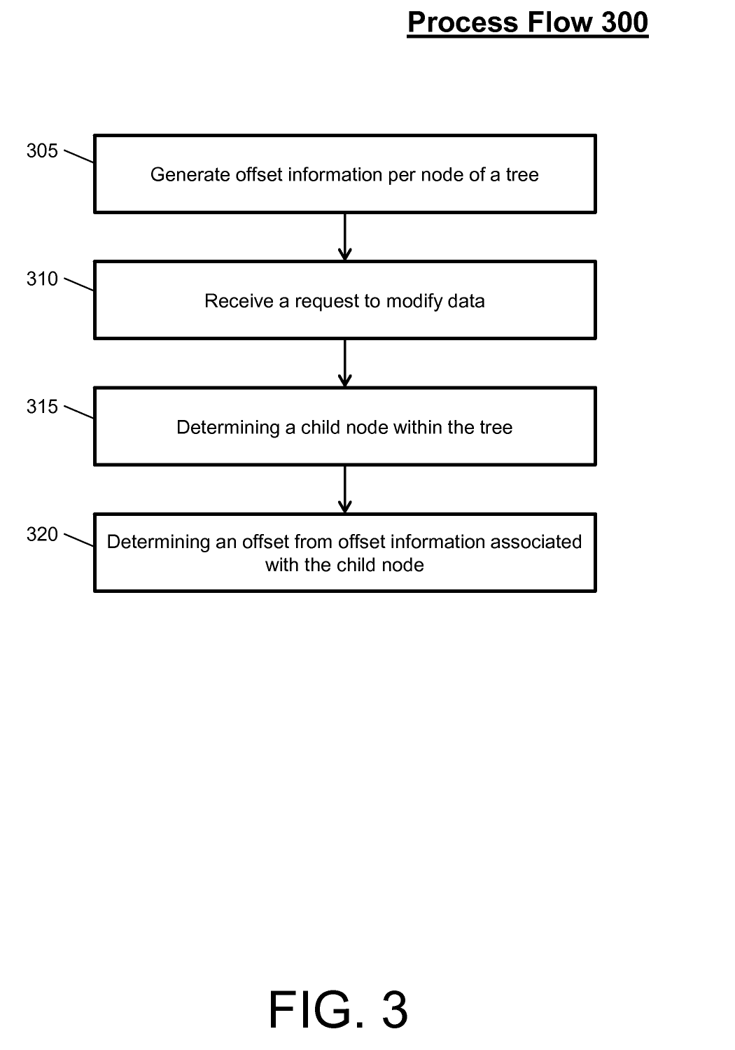

Turning now to FIG. 2, an offset information tree 200 is illustrated in accordance with an embodiment. FIG. 2 will be described with reference to FIG. 3, which illustrates a process flow 300 of system in accordance with an embodiment.

In general, the process flow 300 begins at block 305, where offset information is generated per node of a tree. Each node corresponds to data portions of a data area. Offset information includes a relation between a child node and a parent node, which reflect a distance between a desired data portion in the data area and a start of the data area. This relation can be represented by a formula, and the offset information can include a length of the data portion. Thus, by associating a node with a starting address, the tree utilizes the metadata in that node to calculate an offset of a given field without having to parse an entire data area.

At block 310, a request is received to modify data. The request can be generated by an originator, such as an application or system code. The request identifies a root node and a data portion, along with an expression. The expression enables a child node to be determined or identified based on the root node and the data portion. The root node can be a real root node that begins the entire tree or sublevel parent node that is being utilized as a root node. To illustrate an example, the root node can be Node A of the offset information tree 200.

At block 315, a child node within the tree is determined. For instance, a child node corresponds to the data area that the application or system code is interested in is determined and located from the expression of the request. To further illustrate the example, the child node can be Node N of the offset information tree 200.

At block 320, offset information associated with that child node is utilized to determine an offset of a desired data portion within a data area. This offset facilitates a straight line or direct access to the desired data portion within the data area. Note that the offset information across multiple nodes can merged to determine a location of the desired data portion. For example, a formula of the offset information can be used and/or merged with other values or formulas of other nodes to determine/compute a location of the desired data portion. To further illustrate the example, an offset of Node N (the child node) with respect to Node A (the root node) can be a relative offset of Node N to Node J +a relative offset of Node J to Node D+a relative offset of Node D to Node A. Relative offsets allow a root node to be interchangeable to map memory structures comprising a whole or just a part of the data representation. With the offset determine, the originator can directly access the data portion and perform modification as needed.

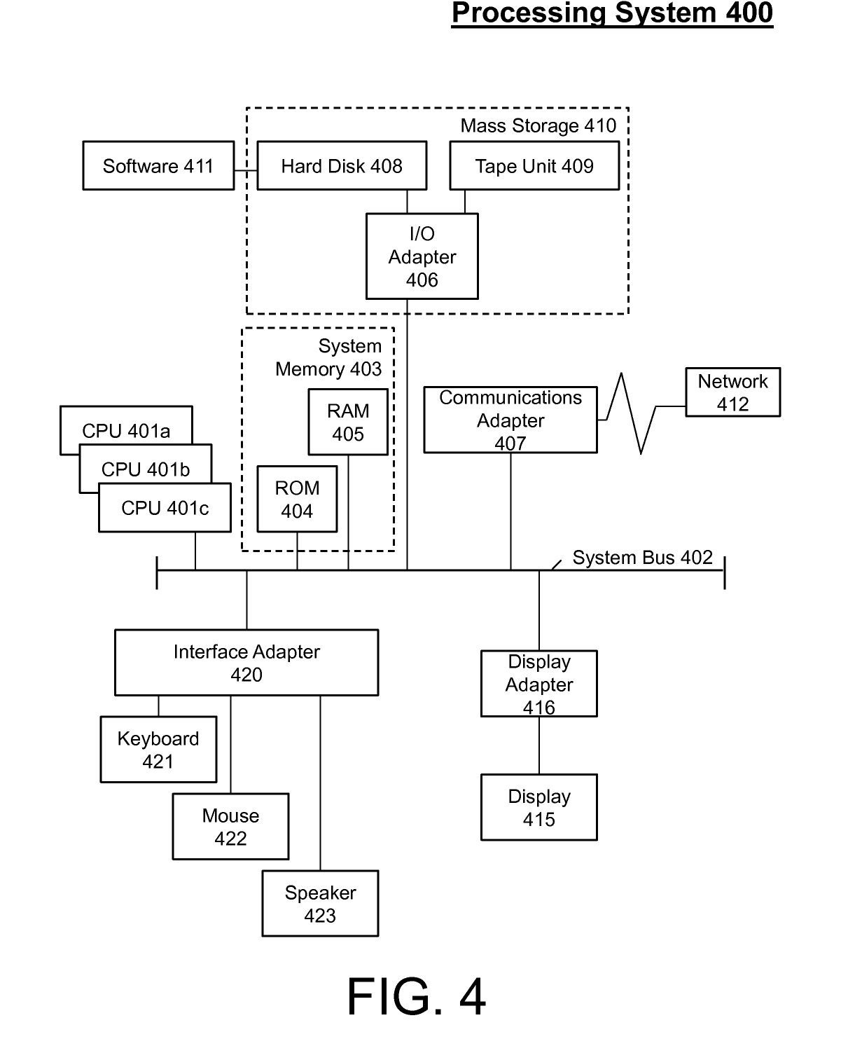

Referring now to FIG. 4, there is shown an embodiment of a processing system 400 for implementing the teachings herein. In this embodiment, the processing system 400 has one or more central processing units (processors) 401a, 401b, 401c, etc. (collectively or generically referred to as processor(s) 401). The processors 401, also referred to as processing circuits, are coupled via a system bus 402 to system memory 403 and various other components. The system memory 403 can include read only memory (ROM) 404 and random access memory (RAM) 405. The ROM 404 is coupled to system bus 402 and may include a basic input/output system (BIOS), which controls certain basic functions of the processing system 400. RAM is read-write memory coupled to system bus 402 for use by processors 401.

FIG. 4 further depicts an input/output (I/O) adapter 406 and a network adapter 407 coupled to the system bus 402. I/O adapter 406 may be a small computer system interface (SCSI) adapter that communicates with a hard disk 408 and/or tape storage drive 409 or any other similar component. I/O adapter 406, hard disk 408, and tape storage drive 409 are collectively referred to herein as mass storage 410. Software 411 for execution on processing system 400 may be stored in mass storage 410. The mass storage 410 is an example of a tangible storage medium readable by the processors 401, where the software 411 is stored as instructions for execution by the processors 401 to perform a method, such as the process flows of FIGS. above. Network adapter 407 interconnects system bus 402 with an outside network 412 enabling processing system 400 to communicate with other such systems. A screen (e.g., a display monitor) 415 is connected to system bus 402 by display adapter 416, which may include a graphics controller to improve the performance of graphics intensive applications and a video controller. In one embodiment, adapters 406, 407, and 416 may be connected to one or more I/O buses that are connected to system bus 402 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 402 via an interface adapter 420 and the display adapter 416. A keyboard 421, mouse 422, and speaker 423 can be interconnected to system bus 402 via interface adapter 420, which may include, for example, a Super I/O chip integrating multiple device adapters into a single integrated circuit.

Thus, as configured in FIG. 4, processing system 405 includes processing capability in the form of processors 401, and, storage capability including system memory 403 and mass storage 410, input means such as keyboard 421 and mouse 422, and output capability including speaker 423 and display 415. In one embodiment, a portion of system memory 403 and mass storage 410 collectively store an operating system, such as the z/OS or AIX operating system from IBM Corporation, to coordinate the functions of the various components shown in FIG. 4.

Technical effects and benefits include direct access to data portions of a data area via a tree of metadata and facilitating flexibility with respect to any starting location within the data area. For example, contemporary parsers parse each data area into a tree and then the data is extracted from that instance of the tree; conversely, embodiments herein parse metadata once to create a tree and can be applied to any data area of any type. Thus, embodiments described herein are necessarily rooted in a processing system to perform proactive operations to overcome problems specifically arising in the realm of data access (e.g., these problems include overhead generated due to traversing a tree when locating a particular field or element of a data area, resulting in unwanted costs and expenses).

Embodiments may include system, a method, and/or a computer program product at any possible technical detail level of integration. The computer program product may include a computer readable storage medium (or media) having computer readable program instructions thereon for causing a processor to carry out aspects of embodiments herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments herein may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments herein.

Aspects of the embodiments herein are described herein with reference to flowchart illustrations and/or block diagrams of methods, apparatus (systems), and computer program products according to embodiments herein. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. (canceled)

2. (canceled)

3. (canceled)

4. (canceled)

5. (canceled)

6. (canceled)

7. A computer program product, the computer program product comprising a computer readable storage medium having program instructions embodied therewith, the program instructions executable by a processor to cause the processor to perform:
generating an offset information tree comprising a plurality of nodes, each node including offset information that corresponds to a data portion of a data area;
identifying a node from the plurality of nodes, the identifying in response to a request for access to the data area;
determining offset information from the node identified from the plurality of nodes; and
utilizing the offset information to directly access a desired data portion of the data area.

8. The computer program product of claim 7, wherein the offset information comprises a relation of a child node to a parent node.

9. The computer program product of claim 7, wherein the program instructions are further executable by the processor to cause:
receiving the request from an originator to access the desired data portion.

10. The computer program product of claim 7, wherein the request identifies a root node and the desired data portion, along with an expression that enables the node identified from the plurality of nodes to be identified based on the root node and the data portion.

11. The computer program product of claim 7, wherein the offset information across multiple nodes of the plurality of nodes is merged to determine a location of the desired data portion.

12. The computer program product of claim 7, wherein the offset information tree is configured to manage multiple data areas of a same type.

13. A system, comprising a processor and a memory storing program instructions thereon, the program instructions executable by the processor to cause the system to perform:
generating an offset information tree comprising a plurality of nodes, each node including offset information that corresponds to a data portion of a data area;
identifying a node from the plurality of nodes, the identifying in response to a request for access to the data area;
determining offset information from the node identified from the plurality of nodes; and
utilizing the offset information to directly access a desired data portion of the data area.

14. The system of claim 13, wherein the offset information comprises a relation of a child node to a parent node.

15. The system of claim 13, wherein the program instructions are further executable by the processor to cause the system to perform:
receiving the request from an originator to access the desired data portion.

16. The system of claim 13, wherein the request identifies a root node and the desired data portion, along with an expression that enables the node identified from the plurality of nodes to be identified based on the root node and the data portion.

17. The system of claim 13, wherein the offset information across multiple nodes of the plurality of nodes is merged to determine a location of the desired data portion.

18. The system of claim 13, wherein the offset information tree is configured to manage multiple data areas of a same type.
